(19) United States
(12) Patent Application Publication
(10) Pub. No.: US 2004/0091588 A1
(43) Pub. Date: May 13, 2004

(54) Food processing apparatus and method

(76) Inventor: Xiaochun Li, Madison, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/699,347

(22) Filed: Oct. 31, 2003

Related U.S. Application Data
(60) Provisional application No. 60/422,763, filed on Oct. 31, 2002.

(51) Int. Cl. A23L 3/00

(52) U.S. Cl. 426/248

(57) ABSTRACT

A method of processing a food product includes providing a source of pulse ultraviolet (UV) radiation. In operation, the method includes directing the UV radiation at the food product to photo-ablate the food product. A combination of parameters associated with the radiation may be selected, including at least one of a group of radiation focus spot size, radiation pulse repetition rate and source power to alter a performance characteristic of the technique, such as food processing speed.

### CROSS-REFERENCE TO RELATED APPLICATION

This application is a non-provisional application based on a provisional application filed under 35 U.S.C. §119(e) on Oct. 22, 2002, which application is expressly incorporated by reference herein in its entirety.

### BACKGROUND OF THE INVENTION

1. Field of the Invention

The present invention is directed to a tool for machining and/or marking biomaterial composites, such as cheese, and more particularly, a tool employing an ultraviolet (UV) laser that operates based on photo-ablation.

2. Description of Related Art

Using conventional systems, most food products may be offered in any of a number of machined forms including shredded, diced, grated and sliced. Moreover, personalized packaging, including marking and labeling, has become a matter of significant interest to manufacturers and customers of food stuffs.

Food processing, including cutting and marking, has taken on many forms over the years. Most such systems are mechanical in nature and are relatively complex, and thus subject to wear and significant maintenance.

One application of particular interest is cheese processing. A traditional way of cutting cheese includes introducing the cheese to running wire knives. Notably, when utilizing such an apparatus, a rough cut may result in loss of texture and taste. In other systems, automated features are included in the machines that allow some such systems to process (e.g., cut) food products at high speed. Nevertheless, most automated cheese and other food handling machines are expensive and normally not flexible with respect to machining food products into various forms, including producing shredded or grated cheese.

As an alternative, laser-based processing has been employed in a variety of areas. In one such system, laser marking on the surface of cheese and other delicatessen food products has been employed. In such a process, a laser is used to focus on an area to be marked. The laser is then actuated to produce the desired result, such as etched text. Notably, known laser-based techniques such as this are thermal processes, where the corresponding heat introduced to the system performs the food processing. The results are often undesirable for a number of reasons. For instance, even if the laser spot used to do the marking is small, local areas of the product (e.g., cheese) will typically be removed entirely by the resultant burning, thus wasting significant portions of the product. Moreover, the quality of the cut is most often less than ideal due to the fact that the food product often melts under increased system temperature. And, the aroma produced can be unbearable when processing certain foods, including cheese. Other laser-based food processing techniques have been employed, such as in the potato industry but each of these processes are thermal processes as well.

Overall, known laser-based food processing techniques have beneficial qualities including minimizing contamination (for example, because no blade is used), and maintaining high reliability due to the fact that a minimum of mechanical structure is employed. However, the problems attendant with laser-based thermal processes such as those described above, including wasted product, poor cut, etc., make such systems inconvenient/unworkable for the applications contemplated by the present invention. Other laser-based cutting/marking techniques have been employed, for example, in the areas of woodworking and photography, but such systems are likewise thermal in nature and therefore not particularly suited for many applications, including food processing.

In view of the above, the dairy and other food product industries have a need for a versatile, or easily reconfigurable, and inexpensive food handling apparatus for processing, for example, cheese. Any such system will preferably be capable of machining the food product into different forms, including producing customer-designed three-dimensional shapes or geometries. Moreover, personalized packaging, including marking and labeling, should also be included in its capabilities. Preferably, the system should be a non-thermal process that provides a smooth cut and a minimum of product waste.

### SUMMARY OF THE INVENTION

The preferred embodiment is directed to a laser-based cutting/marking apparatus and method for processing food products such as cheese using photo-ablation. Preferbably, an ultraviolet (UV) laser is employed. By controlling the parameters of the process, including the focus spot size of the laser, repetition rate of the laser, and the laser power, high food processing yield and quality can be maximized at a relatively low cost.

According to one aspect of the preferred embodiment, a method of processing a food product includes providing a source of pulse ultraviolet (UV) radiation. In addition, the method includes directing the UV radiation at the food product to photo-ablate the food product.

According to another aspect of this embodiment, the method includes selecting a combination of parameters associated with the radiation. In this case, the parameters may include at least one of a group including radiation focus spot size, radiation pulse repetition rate and source power.

In another aspect of this embodiment, the method further includes adjusting the parameters to alter a performance characteristic of the method. For example, the performance characteristic may be food processing speed.

According to a further aspect of this embodiment, the UV radiation has a wavelength less than or equal to about 400 nm. More preferably, the UV radiation has a wavelength equal to about 266 nm.

In another aspect of the preferred embodiment, an apparatus for processing a food product includes a laser that emits radiation having a wavelength in the ultraviolet range. In addition, the combination of parameters associated with the radiation is selected so that the laser photo-ablates the food product.

In another aspect of this embodiment, the parameters include at least one of a group including radiation focus spot size, radiation repetition pulse rate and source power. In addition, the combination may be selected based on a characteristic of the food product, such as hardness.

According to a still further aspect of the preferred embodiment, an apparatus for processing a food product includes a laser emitting radiation having a wavelength in the ultraviolet range, whereby said laser directs the radiation towards a food product so as to photo-ablate the food product.

In another aspect of this embodiment, the radiation is defined by a combination of parameters. Preferably, the combination includes focus spot size, pulse repetition rate, and laser power. Moreover, the combination generally corresponds to at least one of a group including a processing performance characteristic and a characteristic of the food product being processed.

According to another aspect of the preferred embodiment, the method of processing the food product includes providing a laser that generates ultraviolet (UV) radiation, and selecting operation parameters associated with the laser, wherein the parameters include radiation focus spot size, radiation pulse repetition rate and source power. In addition, the method includes directing the UV radiation towards the food product so as to photo-ablate the food product.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a schematic view of an ultraviolet laser used to process food according to the preferred embodiment;

FIGS. 2A and 2B are schematic side elevational views of a product to be processed by the UV laser of FIG. 1, illustrating the product before and after photo-ablation respectively;

FIG. 3 is a graph showing cutting depth versus energy intensity of the laser of the preferred embodiment, shown for the case in which the product is cheese;

FIG. 4 is a flow chart illustrating a process of photo-ablating a food product according to the preferred embodiment;

FIG. 5 is a graph illustrating hole depth versus laser energy fluence;

FIGS. 6(a) and 6(b) are sample cross-sectional views of hole drilling operations according to the preferred embodiment; and

FIG. 7 is a graph illustrating width of kerf versus interactive ratio.

### DETAILED DESCRIPTION OF THE PREFERRED EMBODIMENT

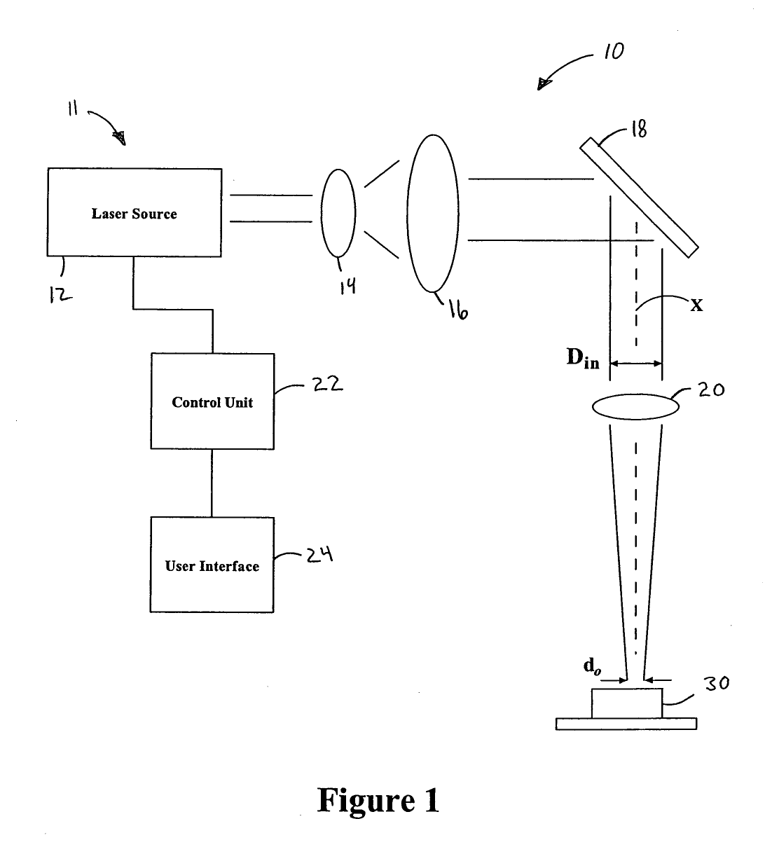

Turning initially to FIG. 1, a food processing system 10 according to the preferred embodiment includes a laser 11 having a source 12 that produces a beam of electromagnetic energy, preferably a beam in the ultraviolet frequency range, that is to be directed toward a food product to be processed. Laser 11 is preferably controlled by a control unit 22 that communicates with a user interface 24 to actuate laser 11 according to the user's desired processing performance characteristics, discussed below.

Laser beam “B” is directed towards a lens 14 that focuses the UV energy prior to its being input to a collimator 16. Collimator 16 outputs a beam comprising parallel rays of electromagnetic energy which is directed towards a reflector 18. Reflector 18 directs the beam toward a focus lens 20, whereby the output beam has a beam axis X and a cross-sectional diameter “D.” Focus lens 20 focuses the collimated beam to a focus spot having a cross-sectional diameter, dₒ. Preferably, the focus spot size, dₒ, is approximately 10 to 100 microns. More particularly, the focus spot size, dₒ, is proportional to the frequency divided by the cross-sectional diameter “D” of the collimated laser beam reflected by reflector 18. Or, more particularly, with reference to FIG. 1,

dₒ=4λM²/(πDᵢₙ) Equation 1

where λ is the wavelength, M² is the laser “times diffraction limit” (i.e., conventionally known as a measure of the quality of the laser), Dᵢₙ is the width of the incoming multi-mode beam. As discussed in further detail below, the focus spot size is selected based on the desired processing characteristics, as well as the type of food product being processed.

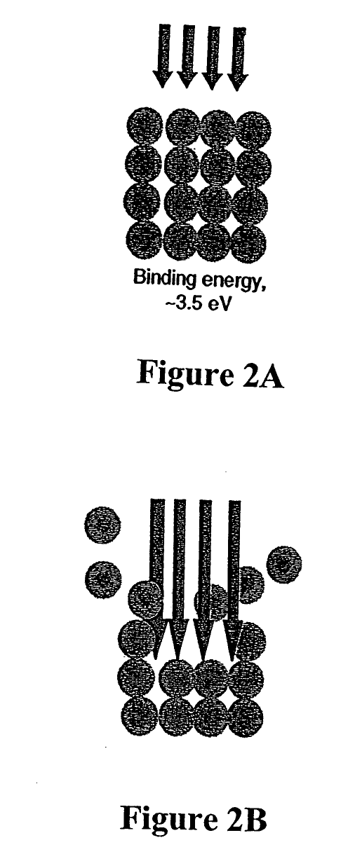

Turning to FIGS. 2A and 2B, a product processed by UV laser 11 is illustrated. In FIG. 2A, a product 30, such as cheese, is shown in cross-section whereby UV laser photon energy generated by laser 11 according to user-defined specifications is directed toward the food product, preferably generally orthogonally thereto, to cut/mark the product 30.

The cutting/marking is accomplished via photo-ablation, whereby the binding energy of the molecules of the product to be processed is overcome, causing particles of the food product to be “blasted” away without heating the product to be processed. More particularly, the molecules of the product 30 absorb the photon energy in the UV range to cause photo-ablation.

In the case of cheese, the binding energy is approximately 3.5 eV. As the UV photons continue to impinge upon the cheese at an ultraviolet photon energy of about 3.1 ev to 6.5 ev, the binding energy between the atoms of the cheese is broken, thus causing a cutting or marking of the food product, as illustrated in FIG. 2B. Importantly, again, the cheese does not melt; rather, photo-ablation causes atoms to be “blasted” from the product, relatively in tact. As a result, a relatively clean cut or mark is achieved, typically with a minimum waste of product.

When processing cheese, a cut on the order of 10 to 50 microns can be achieved, thus highlighting that the process yields a minimum of product waste. And, topographical measurements typically show surface roughness on the sub-micron level for cheese, thus preserving texture and taste. This is due to, among other things, the lack of melting in this non-thermal process, contrary to other known laser-based food processing techniques.

The photon energy is proportional to Planck's constant (h=6.626×10⁻³⁴ J • s) times the frequency, such that the lower the wavelength (inversely proportional to the frequency) of the radiation, the greater the photon energy. The preferred wavelength of the UV energy, which is generally less than 400 nanometers, was determined to be about 150 and 375 nm, and most ideally, approximately 266 nanometers. Overall, notably, laser photo-ablation according to the preferred embodiment can be utilized on a large scale with a minimum of product waste.

A Q-switched pulsed ND:YAG laser is preferably employed as an ultraviolet laser source, using the 3^{rd} and 4^{th} harmonic wavelengths (355 nm and 266 nm, respectively). The flash lamp pumped Nd:YAG laser produces 10 nanosecond-long pulses with average power up to 40 W at 1064 nm, 20 W at 1064 nm, 20 W at 532 nm, 10 W at 355 nm, and 3.5 W at 266 nm at a repetition rate of 20 Hz. The beam has TEM₀₀ mode and the divergence of 0.5 mrad.

Preferably, the system includes a laser system, an optical system and a X-Y-Z microstage. The optical setup consists of three prisms to deliver the laser beam, a focusing lens with the focal length of 135.3 mm (for the laser wavelength of 355 nm) and 128.9 mm (for the laser wavelength of 266 nm), a CCD camera with a maximum magnification of 3200× to monitor micro processes. Image acquisition hardware and software is also included. For the accurate linear movement, a PC-controlled three-axis micro-stage, with a resolution of about 30-nanometers and a travel speed of up to about 200 mm/s is also implemented.

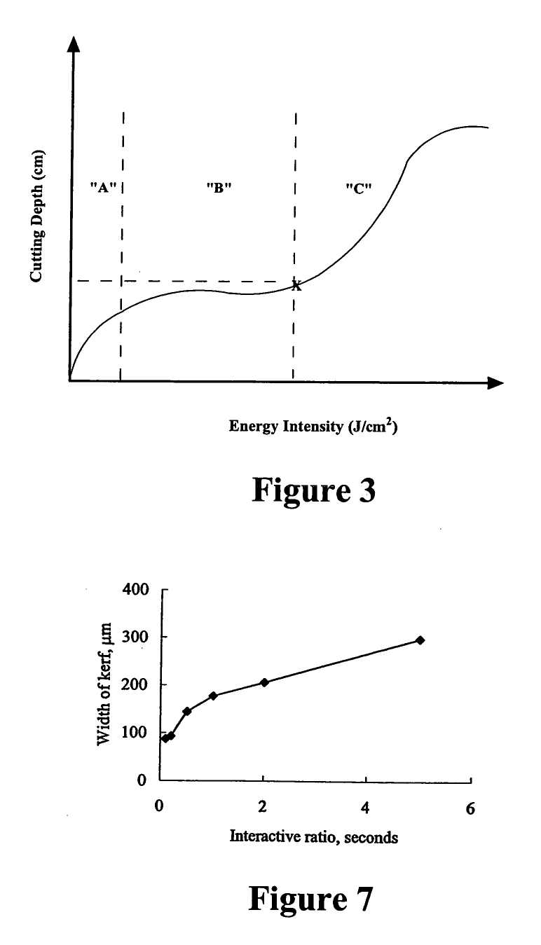

Turning to FIG. 3, a performance graph of the cutting depth versus the energy intensity of laser 11 in a single pulse is shown for the case in which the product to be processed is cheese. Notably, energy intensity depends on operating parameters of the UV laser 11 including focus spot size and laser power. These parameters are selected by the user according to the user's application specifications upon analyzing the corresponding performance graphs, such as that shown in FIG. 3.

Based on the region of the profile that the user wants to operate to obtain the desired cutting depth, appropriate operating parameters can be determined or selected so laser 11 produces the corresponding energy intensity. The goal is to operate on a portion of the FIG. 3 curve that efficiently uses the laser to achieve the desired cutting depth for a higher speed for the corresponding food product being processed.

With more particular reference to FIG. 3, for cheese, the cutting depth increases rapidly in Region “A,” as the energy intensity is increased from a resting state. Energy intensity may be increased by, for example, increasing laser power, etc. Cutting depth then flattens in a mid-range energy intensity at about Region “B.” This is caused by thermal effect and plasma generated by the input laser beam. Thereafter, as the energy intensity is increased further, the cutting depth once again increases in Region “C.” However, in Region C, the process may become thermal, and thus melting of the cheese becomes an issue. Ideally, when processing cheese illustrated in FIG. 3, the user may want to operate at the transition point from Region A to Region B since the cutting is efficient (e.g., minimum waste) without severe thermal effect.

By appropriately setting UV laser 11 operating parameters based on desired processing speed and cutting depth, and thus, among other things, the energy intensity of the laser beam generated by laser 11, the desired cutting/marking of the food product can be achieved. More particularly, by appropriately selecting the focus spot size, dₒ, as well as the power of source 12, precision processing of food products can be realized using photo-ablation. The speed with which cutting/marking can be achieved will depend on the laser pulse repetition rate. The laser may be operated at 20 Hz, to as high as about a few MHz, thus providing cutting/marking speed on par with more conventional apparatus, such as mechanical systems.

Pulse rate is normally fixed in the laser system. Typically, a high pulse rate is preferred so as to maximize processing efficiency, e.g., processing speed. And, the laser power and spot size must be chosen carefully according to FIG. 3. Since laser intensity is the laser power over the spot area, suitable power and spot size are necessary to operate at the transition point from Region A to Region B (from FIG. 3) so as to produce cutting that is efficient without severe thermal effect.

Laser scanning speed determines the cutting depth for a given (e.g., selected) laser intensity, for example, the intensity corresponding to the transition between regions A and B in FIG. 3. Higher speed will reduce the cutting depth.

Normally, UV laser operating parameters are set before processing. Moreover, speed and cutting depth are set according to the type of processing operation to be performed, for example, slicing or grating. For instance, when grating, scanning speed is increased as cutting depth is relatively low, whereby the grating function is facilitated by, for instance, the orientation of the food product to be processed.

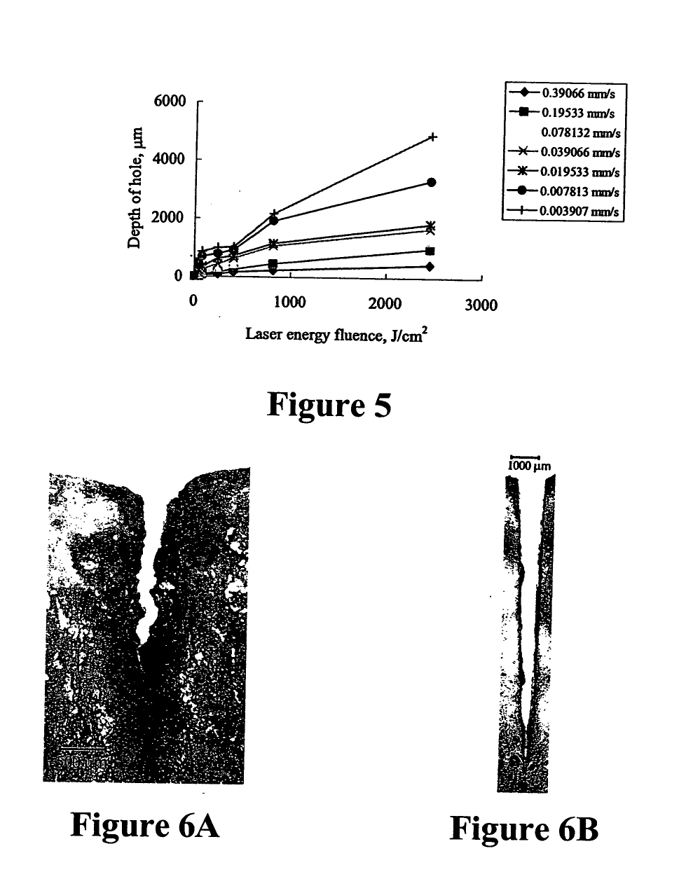

As an example, during drilling, the depth per pulse increases steadily and then rises rapidly with increasing laser fluence until it approaches approximately 800 J/cm². At higher energy fluence, the drilling depth starts to level off due to, for example, the vapor or plasma plume absorbing and dissipating the increased laser energy. Drilling depth generally increases with the number of pulses at various laser energy fluences. However, after certain number of pulses (e.g., 200 pulses at fluence of 2455.8 J/cm² and 400 pulses at lower laser energy fluence), drilling depth only increases slowly. This may be due to the increased surface area inside the drilled hole, which might absorb more laser energy while more laser beam is reflected off the inside wall. A relationship between cutting depth and laser fluence at about 355 nm energy is shown in FIG. 5, more particularly.

For cutting, a laser beam at 266 nm can be used to cut biomaterial composites (such as cheese) at various laser energy fluences at various feed rates. One defining factor, known as interactive ratio, which is defined as spot size over feed rate, is analogous to the interactive time for continuous wave laser processing. A relationship of cutting kerf size and interactive ratio is shown in FIG. 7. Low interactive ratio generally does not allow adequate energy transfer for melting and cutting of far areas around a laser-scanned path, inducing narrower kerf width. The kerf width increases rapidly with the interactive ratio, and then it starts to saturate at a high enough interactive ratio for the diffusion.

In order to obtain continuous cutting, the feed rate should be selected carefully considering focused laser spot size and laser repetition rate. Overlapping, which can be defined as a ratio of speed (mm/s) to laser repetition rate (Hz), is introduced to characterize the laser cutting process. If a consequent pulse is to overlap on a quarter of the hole generated by a previous pulse, the feed rate should be:

Feed rate (mm/s)=hole diameter (mm) * (1¼) * repetition rate (Hz) Equation 2

Thus, higher feed rate can be obtained with a larger hole diameter, a smaller overlapped area, and a higher repetition rate. However, a combination of a larger hole diameter and a smaller overlapped area will generate a rougher cut surface. In this regard, a higher repetition rate is necessary to improve cutting quality and speed.

Cutting depth increases rapidly with laser energy fluences that pass the ablation threshold. However, each cutting depth starts to saturate once the fluence passes a certain value, which is different at each feed rate. It is clear that a lower feed rate produces a deeper cutting. The cutting kerf width increases rapidly at low interactive ratio (defined as spot size over feed rate) since there is inadequate energy transfer to cause melting and cutting. However, at higher interactive ratio, kerf size starts to saturate. A laser beam at 355 nm can also be used to cut cheese. The results are very similar to those with a laser beam at 266 nm. However, cutting depth is significantly smaller than that with a laser beam at 266 nm, especially at longer interactive ration and higher laser energy fluence. See, for example, FIGS. 6 and 6B, illustrating a cutting cross-section with (a) a laser beam of 39.07 μm at 355 nm (laser fluence of 817.59 J/cm² and interactive ratio of 1.0s), and (b) with a laser beam of 37.89 μm at 266 nm (laser fluence of 818.60 J/cm² and interactive ratio of 1.0s), respectively.

Finally, high quality patterns on cheese with a thickness of about 2.5 mm can be machined with a laser at 26 nm. Patterns can be transported from CAD software by the Nd:YAG laser control system.

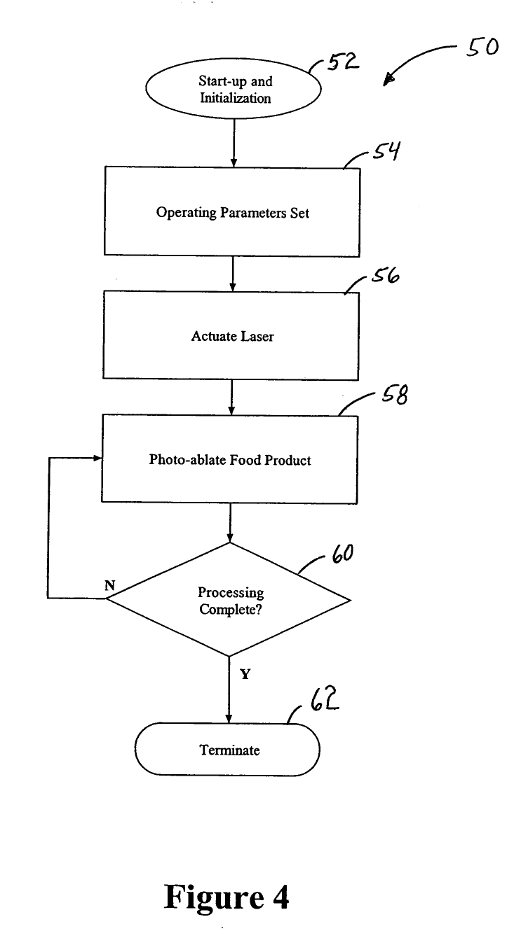

Turning to FIG. 4, a method 50 of processing a food product using a pulsed UV laser is illustrated. After a start-up and initialization Block 52, the UV laser operating parameters, including, inter alia, wavelength, pulse rate, laser power and focus spot size, are set in Block 54. For example, these parameters may be selected by the user manually via interface 24, or downloaded from the control system according to a user's pre-selected processing requirements based on the performance curve (e.g., FIG. 3) associated with the food product to be processed.

The control system then actuates the laser to direct the photo-ablation beam towards the food product in Block 56. Once the binding energy is overcome, photo-ablation occurs, typically for a predetermined time period, and the desired cut/mark is made in Block 58 prior to further processing, for example, of the bulk cheese. In Block 60, the method determines if the cutting/marking operation is complete. If not the photo-ablation process is continued in Block 58 until processing of the food product is complete. Once processing is complete, the method terminates in Block 62.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

What is claimed is:

1. A method of processing a biomaterial composite, the method comprising the steps of:
providing a source of pulsed ultraviolet (UV) radiation; and
directing the UV radiation at the food product so as to photo-ablate the food product.

2. The method of statement 1, further comprising selecting a combination of parameters associated with the radiation.

3. The method of statement 2, wherein the parameters include at least one of a group including radiation focus spot size, radiation pulse repetition rate and source power.

4. The method of statement 3, wherein said selecting step includes increasing the pulse rate so as to increase processing efficiency.

5. The method of statement 2, further comprising adjusting the parameters to alter a performance characteristic of the method.

6. The method of statement 5, wherein the performance characteristic is processing speed.

7. The method of statement 1, wherein the UV radiation has a wavelength in a range equal to about 150 nm to 375 nm.

8. The method of statement 7, wherein the UV radiation has a wavelength equal to about 266 nm.

9. An apparatus for processing a biomaterial composite, the apparatus comprising:
a laser emitting radiation having a wavelength in the ultraviolet range; and
wherein a combination of parameters associated with the radiation is selected so that said laser photo-ablates the food product.

10. The apparatus of statement 9, wherein the parameters include at least one of a group including radiation focus spot size, radiation pulse repetition rate and source power.

11. The apparatus of statement 10, wherein the combination is based on a characteristic of the food product.

12. The apparatus of statement 10, wherein the combination is based on a profile defined by ablation depth versus laser intensity.

13. The apparatus of statement 10, wherein the combination is adjusted according to a performance characteristic.

14. The apparatus of statement 13, wherein the performance characteristic is cutting depth.

15. The apparatus of statement 9, wherein the UV radiation has a wavelength in a range of about 150 nm to 375 nm.

16. The apparatus of statement 15, wherein the UV radiation has a wavelength equal to about 266 nm.

17. An apparatus for processing a food product, the apparatus comprising:
a laser emitting radiation having a wavelength in the ultraviolet range, wherein the radiation is directed towards the food product so as to photo-ablate the food product.

18. The apparatus of statement 17, wherein the radiation is defined by a combination of parameters.

19. The apparatus of statement 18, wherein the combination includes focus spot size, radiation pulse repetition rate, and laser power.

20. The apparatus of statement 17, wherein the combination corresponds to at least one of a group including a processing performance characteristic and a characteristic of the food product.

21. The apparatus of statement 17, wherein the wavelength is about 200 nm.

22. A method of processing a biomaterial composite, the method comprising the steps of:
providing a laser that generates ultraviolet (UV) radiation;
selecting operation parameters associated with the laser, wherein the parameters include radiation focus spot size, radiation pulse repetition rate and source power; and
directing the UV radiation towards the biomaterial composite so as to photo-ablate the food product.
